(19) United States
(12) Patent Application Publication
(10) Pub. No.: US 2009/0053672 A1
(43) Pub. Date: Feb. 26, 2009

(54) Variable temperature dental irrigator

(76) Inventor: Steven Louis Cornelius, Taft, TN (US)

Correspondence Address: Steven L.Cornelius, 9 Blanche Circle, Taft, TN, 38488, US

(21) Appl. No.: 11/894,019

(22) Filed: Aug. 20, 2007

(51) Int. Cl. A61C 17/02

(52) U.S. Cl. 433/80

(57) ABSTRACT

Variable temperature (operator controlled) dental irrigator constructed of three pieces of stainless steel or high-grade aluminum housing two water supply tubes (cold and hot) sealed with O-Rings. The calibrated temperature control valve located on the discharge end of the dental irrigator allows the user (dentist or technician) to adjust the water spray from the irrigator to suit the patient's comfort desire. An additional feature of the irrigator is the interchangeable discharge jets (tips) that may be screwed on/off the main irrigator body for sterilization.

Stainless steel or high-grade hollow aluminum body which contains a mixing valve controlled by a rolling thumb screw and also houses two, one-eighth inch (⅛^{th} inch) diameter medium pressure water supply lines (one hot and one cold) which feed water directly into the mixing valve. The dentist or technician can incrementally warm up or cool down water discharged from the irrigator used to rinse (irrigate) an area of the patient's mouth by executing a ¼^{th} turn (roll) of the mixing valve clockwise or counterclockwise around the axis (handle) of the device —¼^{th} turn left for warmer water, ¼^{th} turn right for cooler water (FIGS. 1 and 3 illustrate how the valve functions).

### BACKGROUND OF THE INVENTION

During many visits to the dentist, as the dentist drilled, scraped and ground away material or packed a tooth full of filling, I have been subjected to very painful jets of cold water from the dental irrigator, which takes its water supply directly from the cold water side of the sink in the examination room. Even with anesthetic numbing of the affected tooth, spraying cold water inside a patient's mouth onto sensitive teeth to rinse the area being examined or worked on, can be very painful. Warming the water spray just a few degrees can make a significant difference in the patient's comfort level. Elevating the water spray temperature from around 55-60 degrees F. (the normal temperature of cold water directly from an outside source), to a possible temperature range of 80-95 degrees F., by blending hot water into the stream sprayed into a patient's mouth would make a significant difference.

After being subjected to an excruciatingly cold stream of water for about the 6^{th} time during one particular dental visit, it occurred to me that there had to be a simple and reasonably inexpensive way to correct this situation. To pass the time while all the drilling and grinding was going on in my mouth, and bracing myself for the next blast of cold water, I thought about ways to eliminate this painful aspect of dental visits. I quickly realized that if the water jet coming from the irrigator was heated to a temperature range of approximately 80-95 degrees F., prior to being sprayed into the patient's mouth the rinsing/cleansing part of the procedure would be much more comfortable. An additional benefit of using warmer water to rinse/irrigate is that it tends to dissolve and dislodge blood, saliva, glue, amalgam shavings, dental coatings and other substances deposited during dental work from tooth surfaces and gum areas much faster than cold water, requiring less frequent irrigations and less water pressure thus shortening the time needed by the dentist/technician to complete his/her work.

This patent submission represents my proposed solution.

### BRIEF SUMMARY OF THE INVENTION

A three piece device made of stainless steel or high grade aluminum, milled into the necessary tubular shape (long slender handle housing the mixing valve, temperature control wheel and hot/cold water supply lines). The discharge end of the irrigator handle consists of a detachable/interchangeable head (permits use of multiple types of jets, tailored for specific dental needs), the grippable housing, which is approximately seven inches long and ⅝^{th} inch in diameter to accommodate the spray output volume control and mixing valve. The butt plate is designed so that the ⅛^{th} inch flexible hot and cold water supply lines can be securely attached. Each section screws together securely, fastening each section together, and uses high temperature o-rings to make the final assembled unit water proof. This design allows the device to be autoclaved as one sealed unit or broken down into three separate pieces for sterilization.

### BRIEF DESCRIPTION OF THE SEVERAL VIEWS OF THE DRAWINGS

FIG. 1 depicts a cross section of the entire device, showing the temperature control thumb wheel (mixing valve), water supply tubes and pressure/feed valve, as well as the waterproof end cap with interchangeable jets.

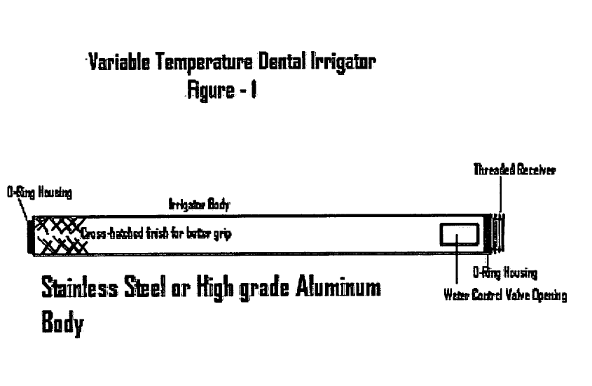

FIG. 2 illustrates the interior of the irrigator with integrated supply tubes, mixing valve and water volume control valve.

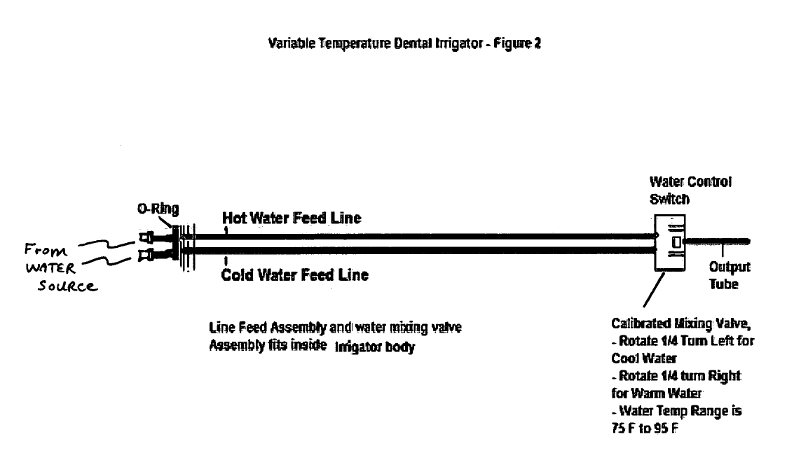

FIG. 3 shows the water volume and temperature control mixing valve

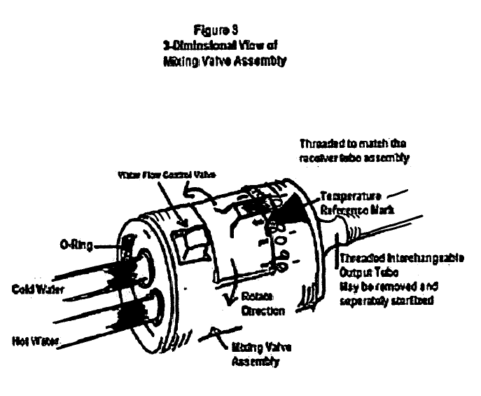

### DETAILED DESCRIPTION OF THE INVENTION

Stainless steel or high-grade hollow aluminum body which contains a mixing valve controlled by a rolling thumb screw. The hollow handle also houses two, one-eighth inch, medium pressure water supply lines (one hot and one cold) which feed water directly into the mixing valve. The dentist or technician can warm up or cool down water used to rinse or irrigate an area of the patient's mouth on demand by executing a ¼^{th} turn (roll) of the mixing valve around the handle of the device —¼^{th} turn left for warmer water, ¼^{th} turn right (Drawing #1 illustrates how the valve functions). Three piece device made of stainless steel or high grade aluminum, milled into the necessary tubular shape (long slender handle housing the mixing valve, temperature control wheel and hot/cold water supply lines). The handle of the irrigator will be hollow and consist of a detachable/interchangeable head (allows use of multiple types of jets, tailored for specific needs), the grippable housing with volume control and mixing valve, and the butt plate designed to so that the ⅛^{th} inch flexible hot and cold water supply lines can be securely attached. Each section will screw together for secure fastening and use temperature resistant o-rings to make the assembled unit water proof. This design allows the device to be autoclaved as one sealed unit or broken down into three separate pieces for sterilization. Other design features are:
1) Irrigator handle is milled with cross-hatches to ensure a non-slip, grippable surface;
2) Uses two rigid (brass) or semi-flexible (Trex) supply lines permanently housed in the irrigator handle;
3) The entire irrigator is capable of being broken into three discreet pieces for cleaning and repair;
4) A calibrated temperature control valve can be moved left or right by rolling it axially around the handle of the irrigator.
5) The discharge end of the irrigator may be changed to alter the spray pattern as the treatment or dentist requires it.

Key design and manufacturing characteristics are:
I. Incorporates two water supply lines (rigid or flexible), depending upon application;
II. Uses heat-resistant rubber O-Rings to seal the valve and water supply lines within the device—allowing the instrument to be sterilized in an autoclave;
III. Candidate construction material is stainless steel or aircraft quality aluminum alloy;
IV. A calibrated, thumb controlled mixing valve located near the dentist's right thumb or right index finger permits precise adjustments of the mixing valve “on demand”;
V. Size—the grippable housing is approximately seven inches long and ⅝^{th} inch in diameter to accommodate the spray output volume control and mixing valve. The butt plate is designed so that the ⅛^{th} inch flexible hot and cold water supply lines can be securely attached. The entire apparatus weighs approximately 8 ounces.

1. The improved, Variable Temperature Dental Irrigator is unique in that it allows hot water to be mixed with cold water to deliver a range of warm or cool water on demand to clean/rinse an area of the patient's mouth (see illustration/drawing #2). Currently, dental irrigators are constructed of high-grade aluminum or stainless steel tubing, but use supply water drawn directly from the cold water supply line in the examination room, much like the cold water supply to an icemaker in your kitchen refrigerator. This water is at least approximately 35-45 degrees cooler than the inside surface of the patient's mouth, resulting in a very painful blast of cold spray, which is exacerbated because the patient cannot close his/her mouth to warm the teeth and gums after such a blast. The Variable Temperature Dental Irrigator eliminates this unnecessary discomfort by heating the water jet to selectable temperature range of 80-95 degrees F. This provides a comfortable stream of water into the patient's mouth and also has the additional benefits of breaking up saliva and dislodging detritus around the tooth caused by dental grinding and filling.
